(19) United States
(12) Patent Application Publication
(10) Pub. No.: US 2008/0181182 A1
(43) Pub. Date: Jul. 31, 2008

(54) Digital radio head system and method

(76) Inventors: Scott Carichner, Rancho Santa Margarita, CA (US); Anthony Demarco, Newport Beach, CA (US)

Correspondence Address: MYERS DAWES ANDRAS & SHERMAN, LLP, 19900 MACARTHUR BLVD., SUITE 1150, IRVINE, CA, 92612, US

(21) Appl. No.: 12/008,344

(22) Filed: Jan. 10, 2008

Related U.S. Application Data
(60) Provisional application No. 60/880,144, filed on Jan. 12, 2007.

(51) Int. Cl. H04J 3/00; H04J 3/06

(52) U.S. Cl. 370/336; 370/350

(57) ABSTRACT

An improved digital radio head system and method for wireless communications is disclosed that simplifies the timing and synchronization between the access network, base station, and radio head. A satellite derived timing source is obtained at one or more of the remote radio heads where it is convenient to obtain and use the timing reference. The reference is transmitted back to the base station, if necessary, to synchronize the two. This is further synchronized at a lower accuracy through the access network.

### RELATED APPLICATION INFORMATION

The present application claims the benefit under 35 USC 119(e) of U.S. provisional patent application Ser. No. 60/880,144 filed Jan. 12, 2007, the disclosure of which is incorporated herein by reference in its entirety.

### FIELD OF THE INVENTION

The invention relates in general to wireless communication base stations and, more particularly, to digital radio heads that are connected to base stations, or access points connected to an aggregator, through a wired communication channel.

### BACKGROUND OF THE INVENTION

Modern wireless communication systems often use remote digital radio heads to their advantage. There are many reasons why it is advantageous to move closer to the antenna the sub-systems that create the RF power from digital data, and those that create the baseband received digital data from the received RF power. In FIG. 1 a typical base station deployment is shown. The base station (180) is connected to an access network (105) at an access-network connection point to provide primary data connection to the larger network. The base station will typically support one or more sectors, each of which is connected to one or more transmit and receive antennas (175) at transmit locations (190) remote from the base stations. By using a digital radio head (160) at the remote locations (190) to support each sector, the required distance between the base station (180) and the antennas (175) can be bridged by a more convenient transmission media (150). (As used herein and consistent with well known terminology in the art, a digital radio head comprises the basic components to provide an RF signal for wireless transmission from an input digital communications signal and includes at least a digital to analog conversion block, up converter circuitry, a power amplifier, and similarly components to receive an RF signal including a low noise amplifier, down converter circuitry, and an analog to digital conversion block. Typically the radio head will include other standard components such as filters and couplers. Therefore, these well known radio head components will not be described further herein. Additional circuitry may also typically be present at the radio head location as illustrated in more detail in FIG. 2 discussed below.) Inexpensive, high performance links to implement (150) are known. Examples are inexpensive transmission lines and fiber optic cables.

If the distance between the radio head and the antenna can be kept small, less expensive cables can be used for the RF link (176) that connects to the antennas (175). The user can use this advantage to decrease system cost or to increase system performance or some combination of the two. There are several existing standardized and proprietary inter-connection methods for the digital link (150). All of these systems transfer critical reference timing from the base station (180) to the remote digital radio heads (160) to meet the performance required from modern wireless communication protocols. All modern wireless protocols (TDMA, CDMA, OFDM) require precision timing to be transferred to the radio heads for many reasons. Some examples are for maintaining precise carrier frequencies, to allow cooperation between different base stations, to identify distances to mobile users, and to minimize inter and intra cell interference.

In FIG. 2 a conventional approach to implementing this synchronization is shown. In this case an inexpensive satellite derived timing source (135) is used to obtain precise time and frequency references. A satellite timing source (135) must be connected to an antenna (140) with preferably unobstructed view of the sky. This can require extra cost and difficulty to implement. A typical satellite timing source, such as GPS (135), supplies a precise frequency reference, often at 10 MHz and a precise 1 pulse-per-second (PPS) signal that is aligned with Greenwich Mean Time (GMT). These signals are fed into a timing generator (125) that will reduce jitter, if necessary on the oscillator, create frequencies that are typically used in wireless base stations (e.g. 30.72 MHz), and make the appropriate framing signals and time-stamping signals.

The baseband module (115) converts a relatively small amount of user data, which includes bearer data and may also include control and management data, into a larger amount of baseband data in the protocol of choice for the base station. This typically requires serialized bit rates in the media interface (120) of hundreds of Mb/s to several Gb/s. This large amount of data is supporting a much lower amount of actual user data in the wireless cell. In fact the ratio is typically between 20 and 100 times of data expansion between the backhaul link (106) and the baseband link (150). This expansion supports the robustness of the wireless link to the well known degradations involved with mobile wireless links.

The timing reference at the base station is fed as shown in FIG. 2 through the media interface (120) in several well known methods. These include some methods standardized by the OBSAI and CPRI standards committees. At the remote radio head a second media interface (155), strips off the encoded information used to transmit the synchronization information and sends it to a timing extractor module (165). The timing extractor (165) regenerates the data in a format similar to the data that came from the timing generator (125). The timing data and frequency reference is used by the digital radio head (160) to control carrier frequencies, data rates, and to transmit the proper baseband sample at the proper time. Conversely it stamps the received data with the proper time so that the base station (180) can process the information correctly.

### SUMMARY OF THE INVENTION

In a first aspect the present invention provides a wireless communications system comprising a base station receiving communications signals from an access network and one or more radio heads remotely configured from the base station and coupled for communication to the base station over a wired transmission link, each radio head coupled to one or more antennas to transmit and receive wireless communications signals. A satellite receiver antenna is configured at the radio head location and a timing generator is also configured at the radio head location and coupled to the satellite receiver antenna. The timing generator extracts timing information from a satellite signal received at the satellite receiver antenna and provides timing signals to the radio head and to the base station, wherein the base station and radio head employ the timing signals to synchronize transmission of communications signals along the wired transmission link between the base station and radio head.

In a preferred embodiment of the wireless communications system the satellite receiver antenna may be a GPS receiver and the satellite signal is a GPS signal. The wired transmission link may be a transmission line or an optical fiber. The timing information from the satellite signal may comprise a frequency reference and the timing generator may include a clock filter to filter the frequency reference. The timing information from the satellite signal may further comprise a periodic real time reference signal and the timing generator may further comprise a framer to provide frames referenced to points in real time derived from the periodic real time reference signal. The timing generator may also further comprise a time stamper which adds a stamp to the timing signal indicating the precise time for a fixed reference point in each frame. The one or more radio heads may comprise a plurality of separate radio heads coupled together through a wired link wherein one radio head is coupled to the base station through the wired transmission link.

In another aspect the present invention provides a wireless communications system, comprising a transport module receiving communications signals from an access network, one or more radio heads remotely configured from the transport module, each radio head coupled to one or more antennas to transmit and receive wireless communications signals, and a baseband processing module configured at the radio head location and coupled to the radio head. The baseband processing module is also coupled to the transport module over a wired transmission link and receives and sends user data to and from the transport module. A timing generator is configured at the radio head location and provides timing signals to the baseband processing module and radio head.

In a preferred embodiment of the wireless communications system the baseband processing module provides physical layer processing. The baseband processing module may also provide MAC layer processing. The wired transmission link may be a transmission line or an optical fiber. The timing generator may also provide timing signals to the transport module. The wireless communications system preferably further comprises a satellite receiver antenna configured at the radio head location and the timing generator extracts timing information from a satellite signal received at the satellite receiver antenna to provide the timing signals to the radio head and to the baseband processing module. For example, the satellite signal may be a GPS signal. The one or more radio heads may comprise a plurality of separate radio heads coupled together through a wired link wherein one radio head is coupled to the transport module through the wired transmission link via the baseband processing module.

In another aspect the present invention provides a method for providing a communications signal from a first location at an access-network connection point to a second location adjacent one or more antennas located remotely from the first location, for wireless transmission at the second location. The method comprises receiving a communications signal from an access-network connection point at the first location, transmitting the communications signal in digital form along a wired transmission link to the second location located remotely from said first location, deriving a timing signal at the second location using an external reference timing source, and performing baseband processing on the digital communications signal at the second location using the timing signal. The method further comprises providing the baseband processed signal to a radio head at the second location.

In a preferred embodiment of the method the baseband processing comprises physical layer processing of the digital communications signals. The baseband processing preferably further comprises MAC layer processing of the digital communications signals. Deriving a timing signal at the second location using an external reference timing source preferably comprises extracting timing information from a satellite signal received at a satellite receiver antenna configured at the second location. The method may further comprise providing the timing signal derived at the second location to the first location for synchronizing transmitting of the communications signal along the wired transmission link between the first and second locations.

Further aspects of the invention will be appreciated by the following detailed description of the invention.

### BRIEF DESCRIPTION OF THE DRAWINGS

FIG. 1 is a block schematic drawing of a communications system architecture in which the present invention may be employed.

FIG. 2 is a block schematic drawing of a conventional approach for implementing timing and a synchronization in a base station with digital radio head.

FIG. 3 is a block schematic drawing of a first preferred embodiment of the present invention.

FIG. 4 is a block schematic drawing of a second preferred embodiment of the present invention.

FIG. 5 is a block schematic drawing of a more detailed description of the timing generator in both preferred embodiments of the present invention.

FIG. 6 is a block schematic drawing of a third preferred embodiment of the present invention.

### DETAILED DESCRIPTION OF THE INVENTION

The invention provides an improved digital radio head system and method of generating the necessary synchronization between the base station baseband processing system and the remote radio heads that are mounted nearer to the antenna tower.

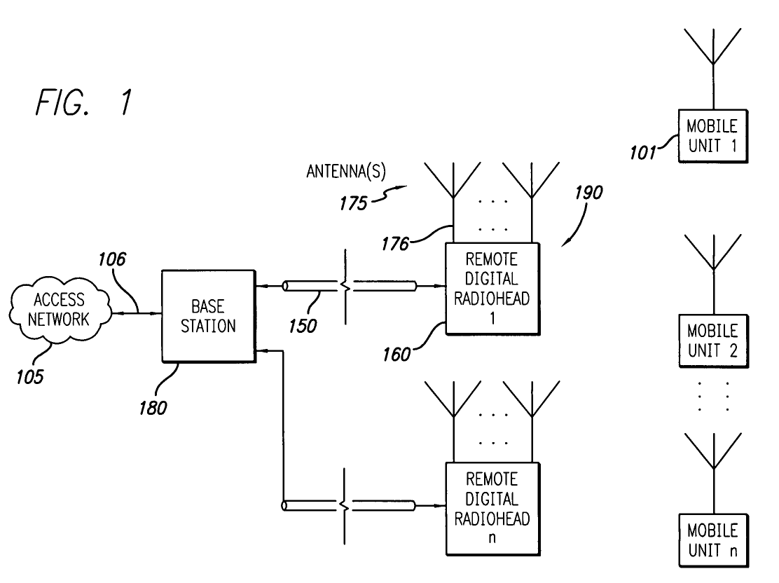

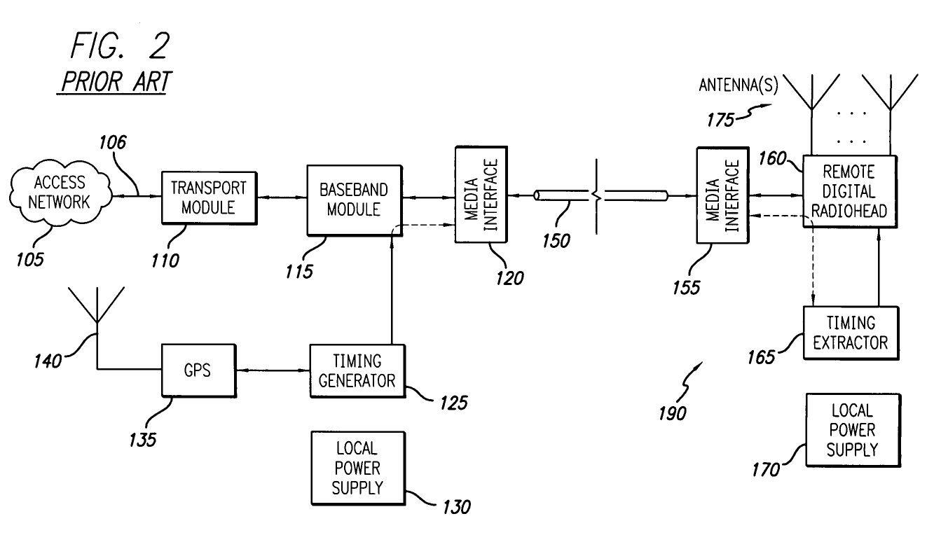

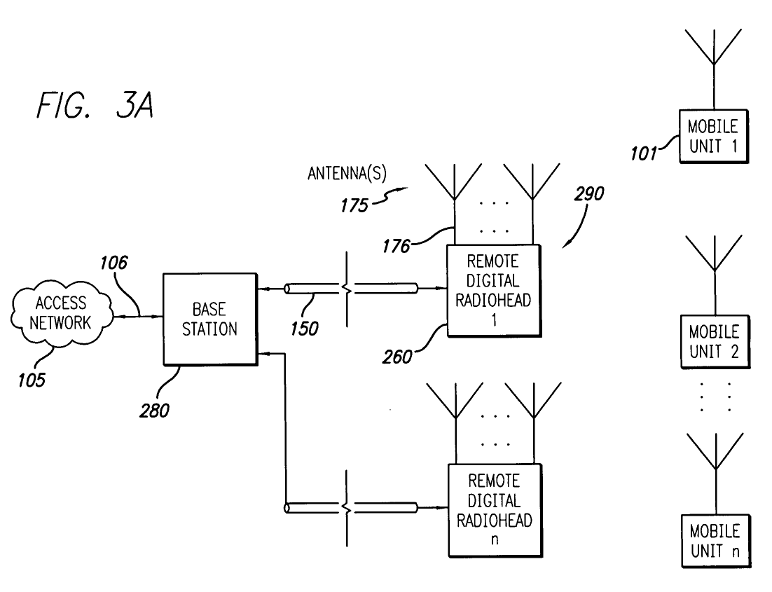

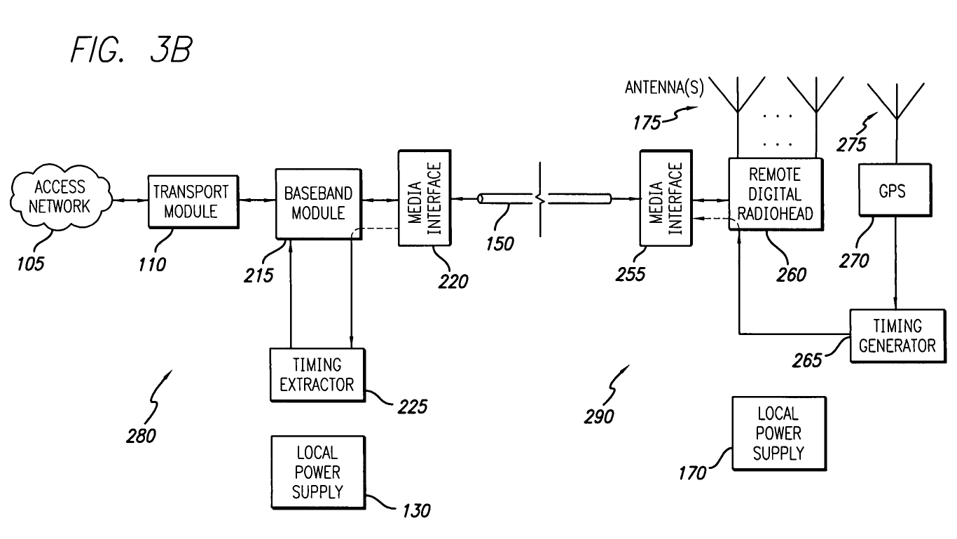

FIGS. 3A and 3B show a first preferred embodiment of the invention. As shown in FIG. 3A the overall architecture of the system is the same as a conventional architecture described above in relation to FIG. 1 but employs a different timing generation and related synchronization and control aspects as shown in FIG. 3B. In this case the timing is generated remotely from the first location (280) at the second remote radio head location (290) via a satellite receiver (270), satellite antenna (275), and timing generator (265). This is advantageous for many reasons. One of which is convenient access to unobstructed satellite antenna mounting space. Another is that the most critical timing is needed in the radio head. Much less precise timing is needed in the baseband module (215). So it is easier to generate the precise timing where it is needed and transfer a less precise timing back to the base station. This provides improved performance and lower system cost. The antenna (275) may be attached to the casing of the radio head (260) or it may be mounted a short distance away and connected by an inexpensive cable. In this first preferred embodiment the main difference is exchanging the timing generation and extraction locations.

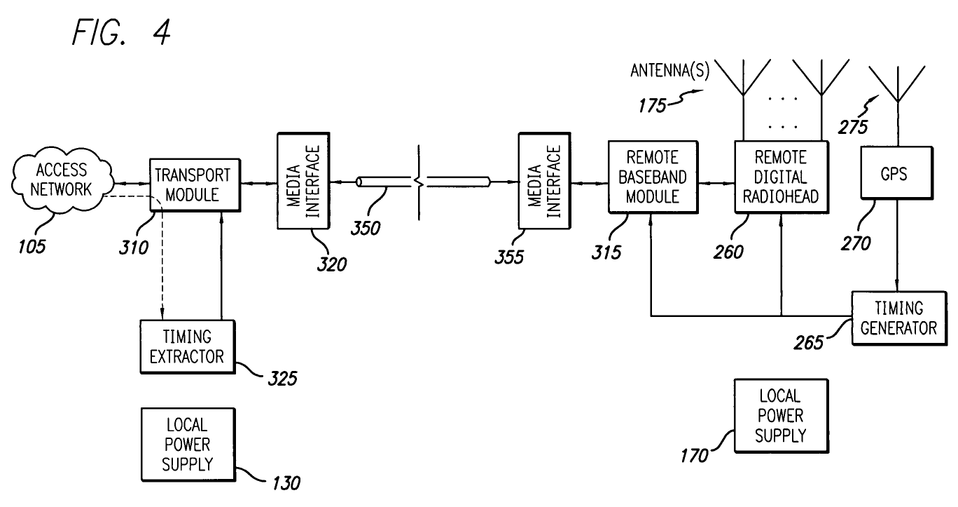

In FIG. 4 a second preferred embodiment of the invention is shown. In this case a modified baseband module (315) is included at the radio head instead of the base station, which baseband module transmits and receives user data to and from the transport module (310). The timing and synchronization is done in the same manner as the first embodiment, at the radio head. In this case advantage is made of the reduced data rate necessary between the transport module (310) and the baseband module (315). The high data rate between the baseband module (315) and the radio head (260) is more easily addressed in this technique using any of a large number of common techniques for transmitting high speed electrical signals between subsystems in a single mechanical enclosure over a short distance. The lower data rate, by a factor of 20 to 100, that is distributed over (350) is much easier to transmit the required distance as determined by the spacing of the media interface (320) at the base station side of the link and a second media interface (355) at the radio head side of the link. In fact, this lowered data rate becomes critical as the number of transmit/receive chains increase as is common in modern Multi-input, Multi-Output (MIMO) air interfaces. The number of MIMO channels, typically 2 or 4 currently, can get even larger and create an extremely large amount of digital data. These channels must be processed with critical timing accuracy, after which the detected or transmitted symbol rate is significantly reduced.

The remote baseband module (315) may contain just the physical layer (PHY) processing, in which case the media access control (MAC) layer processing is included in the functionality of the transport module (310). (The terminology PHY layer and MAC layer is in accordance with standard OSI Model terminology and definitions. Such processing is well known in the art and accordingly is not described further herein.) However, it may also be implemented such that the MAC processing is included in the remote baseband module (315) to improve the cost of the total system or to reduce the subsystems in the base station (180). In both cases the timing critical and data-rate reduction processing occurs in the remote digital radio head (260).

This low speed link requires less accurate timing precision such that timing references as previously used are not necessary. Time-stamping the data packets is sufficient with frame headers to interface to the transport module (310). The transport module (310) can extract the less precise timing needed from the access network (105) itself using standard and proprietary techniques well known in the prior art such as NTP or IEEE-1588 PTP protocols.

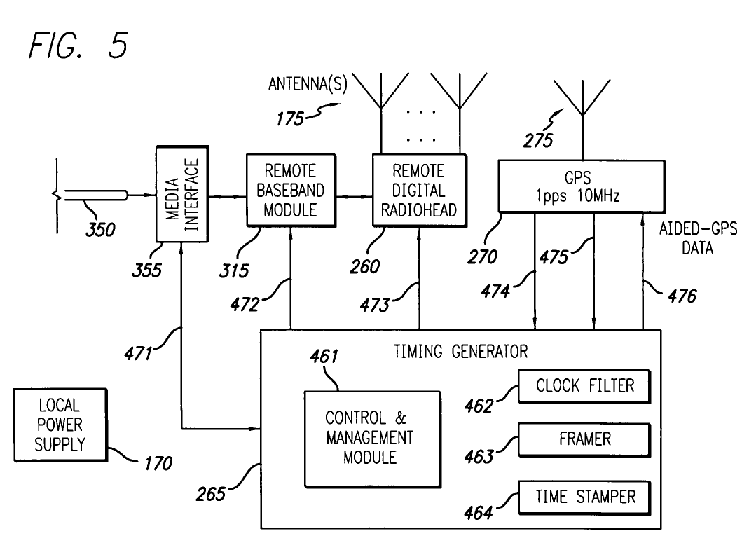

In FIG. 5 the main functional blocks of the timing generator (265) for the second preferred embodiment is shown, but they apply to the first embodiment as well. The satellite timing reference (typically GPS, but not limited to GPS) will supply a precise frequency source (475) of typically 10 MHz. It will also supply a 1 PPS signal that is time-aligned to GMT (474). If the timing ambiguity is greater than one half second in the system, a digital code of the exact time can be extracted from (270), but this is seldom necessary since packet based protocols should have already synchronized the system within hundreds of milliseconds. A feature of this invention also allows that GPS-aiding techniques can be supplied as signals (476) extracted from the timing generator (461), link (350), and transport module (310) to a properly configured satellite receiver so that its synchronization capabilities can be extended when there is low signal to noise ratio in the receive path, possibly due to poor antenna positioning.

The timing generator (265) will provide the functionality in the clock filter (462) to filter the frequency reference (475) to reduce jitter as necessary. It also includes a framer (463) to provide a reference point to real time as supplied from the 1 PPS signal (474). It also includes a time stamper (464) which will indicate the precise time for a fixed reference point in each frame. This may be done in different ways but includes adding frame numbers or time stamps. The timing generator (265) also includes a control and management module that manages the communication channel (350) to the base station via link (471). This module will transmit and receive, code and decode, data on the overhead channels of (350) that include among other things the timing information that is sent back and any messages sent through the network to the radio head for course timing and GPS aiding. The timing signals (472, 473) are sent to their respective modules for use.

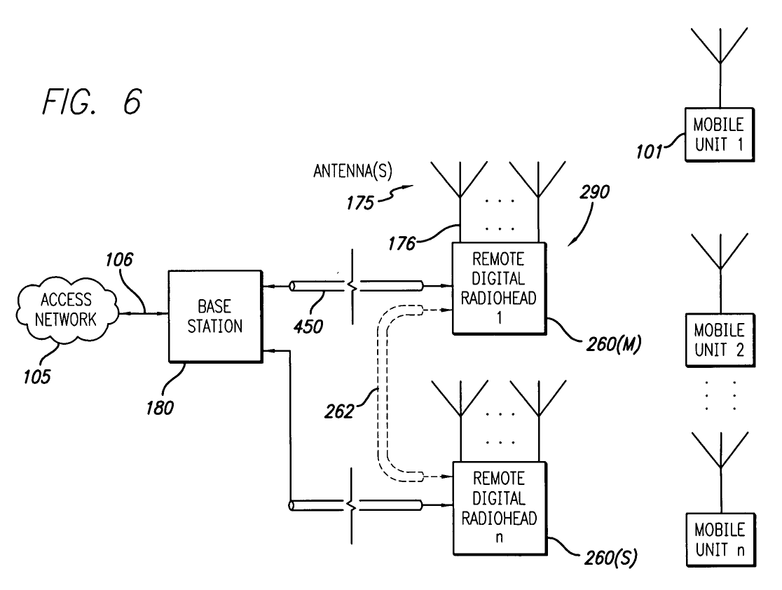

In a third preferred embodiment of the invention shown in FIG. 6 a single link (450) connects the base station (180) to a master digital radio head 260 (M) and nearby additional slave radio heads 260 (S) are connected to the base station (180) through the master digital radio head 260 (M). This mode of operation does not require any substantial change to the digital radio head 260 (M) but it may provide a more cost-effective installation since only one connection is required back to the base station (180). This is feasible because each digital radio head (260) has its own precise timing reference and the aggregate data-rate has been substantially reduced so that it can fit on a single link.

The foregoing embodiments are merely illustrative and not limiting in nature and a variety of modifications may be made within the scope of the present invention.

What is claimed is:

1. A wireless communications system, comprising:
a base station receiving communications signals from an access network;
one or more radio heads remotely configured from the base station and coupled for communication to the base station over a wired transmission link, each radio head coupled to one or more antennas to transmit and receive wireless communications signals;
a satellite receiver antenna configured at the radio head location;
a timing generator configured at the radio head location and coupled to the satellite receiver antenna, the timing generator extracting timing information from a satellite signal received at the satellite receiver antenna and providing timing signals to the radio head and to the base station, wherein the base station and radio head employ the timing signals to synchronize transmission of communications signals along the wired transmission link between the base station and radio head.

2. A wireless communications system as set out in claim 1, wherein the satellite receiver antenna is a GPS receiver and the satellite signal is a GPS signal.

3. A wireless communications system as set out in claim 1, wherein the wired transmission link is a transmission line or an optical fiber.

4. A wireless communications system as set out in claim 1, wherein the timing information from the satellite signal comprises a frequency reference and wherein the timing generator comprises a clock filter to filter the frequency reference.

5. A wireless communications system as set out in claim 4, wherein the timing information from the satellite signal further comprises a periodic real time reference signal and wherein the timing generator further comprises a framer to provide frames referenced to points in real time derived from the periodic real time reference signal.

6. A wireless communications system as set out in claim 5, wherein the timing generator further comprises a time stamper which adds a stamp to the timing signal indicating the precise time for a fixed reference point in each frame.

7. A wireless communications system as set out in claim 1, wherein the one or more radio heads comprise a plurality of separate radio heads coupled together through a wired link and wherein one radio head is coupled to the base station through said wired transmission link.

8. A wireless communications system, comprising:
a transport module receiving communications signals from an access network;
one or more radio heads remotely configured from the transport module, each radio head coupled to one or more antennas to transmit and receive wireless communications signals;
a baseband processing module configured at the radio head location and coupled to the radio head, wherein the baseband processing module is also coupled to the transport module over a wired transmission link and receives and sends user data to and from the transport module also; and
a timing generator configured at the radio head location and providing timing signals to the baseband processing module and radio head.

9. A wireless communications system as set out in claim 8, wherein the baseband processing module provides physical layer processing.

10. A wireless communications system as set out in claim 9, wherein the baseband processing module provides MAC layer processing.

11. A wireless communications system as set out in claim 8, wherein the wired transmission link is a transmission line or an optical fiber.

12. A wireless communications system as set out in claim 8, wherein the timing generator also provides timing signals to the transport module.

13. A wireless communications system as set out in claim 8, further comprising a satellite receiver antenna configured at the radio head location and wherein the timing generator extracts timing information from a satellite signal received at the satellite receiver antenna to provide said timing signals to the radio head and to the baseband processing module.

14. A wireless communications system as set out in claim 12, wherein the satellite signal is a GPS signal.

15. A wireless communications system as set out in claim 8, wherein the one or more radio heads comprise a plurality of separate radio heads coupled together through a wired link and wherein one radio head is coupled to the transport module through said wired transmission link via said baseband processing module.

16. A method for providing a communications signal from a first location at an access-network connection point to a second location adjacent one or more antennas located remotely from said first location for wireless transmission at said second location, comprising:
receiving a communications signal from an access-network connection point at the first location;
transmitting the communications signal in digital form along a wired transmission link to the second location located remotely from said first location;
deriving a timing signal at the second location using an external reference timing source;
performing baseband processing on the digital communications signal at said second location using said timing signal; and
providing the baseband processed signal to a radio head at the second location.

17. A method as set out in claim 16, wherein the baseband processing comprises physical layer processing of the digital communications signals.

18. A method as set out in claim 17, wherein the baseband processing further comprises MAC layer processing of the digital communications signals.

19. A method as set out in claim 16, wherein deriving a timing signal at the second location using an external reference timing source comprises extracting timing information from a satellite signal received at a satellite receiver antenna configured at the second location.

20. A method as set out in claim 16, further comprising providing the timing signal derived at the second location to said first location for synchronizing transmitting of the communications signal along the wired transmission link between the first and second locations.
